(19) United States
(12) Patent Application Publication
(10) Pub. No.: US 2011/0063218 A1
(43) Pub. Date: Mar. 17, 2011

(54) EMBEDDED OMNI-DIRECTIONAL POINTER COMPONENT FOR LIMITED FORM FACTOR COMPUTING DEVICES

(75) Inventor: DAVID HERTENSTEIN, COPPELL, TX (US)

(73) Assignee: INTERNATIONAL BUSINESS MACHINES CORPORATION, ARMONK, NY (US)

(21) Appl. No.: 12/559,678

(22) Filed: Sep. 15, 2009

(51) Int. Cl. G06F 3/033

(52) U.S. Cl. 345/161

(57) ABSTRACT

A MobilePointer pointer controller for hand-held devices that includes an isometric joystick and three buttons; right, middle, and left. The isometric joystick is able to be moved in a variety positions from center. The right button, a middle button, and left button, can each be user selectable buttons. The MobilePointer can be configured for single-hand use while a mobile computing device is being held in the hand that is manipulating the MobilePointer. User-selectable manipulations of the MobilePointer can map to standard mouse events, which permits Applications to respond to standard mouse events as opposed to mobile device specific ones.

### BACKGROUND

The present disclosure relates to the field of user input devices and, more particularly, to embedded omni-directional pointer component for limited form factor computing devices.

Duplicating standard desktop mousing functionality on mobile devices is becoming of greater importance as the division between desktop computing and mobile computing (e.g., limited form factor devices) is blurred. For instance, applications which were previously accessible only on desktop computers are now available on mobile computing platforms (e.g., netbooks, mobile phones). One problem which arises from this shift is that traditional input mechanisms on mobile devices fail to adequately replicate desktop mousing functionality. The result is that many applications fail to operate properly, causing frustration to developers and users.

Consequently, application developers and users are being forced to adapt desktop applications to mobile platforms due to limitations of traditional user input on limited form factor devices (such as hand held devices). These limitations become a great burden to developers as separate mobile versions need to be created to permit mobile device usage. Users too are affected by having to constantly modify user input behavior for each mobile device being used. That is, user behavior is device dependent, unlike standard desktop computer mice.

Traditional input mechanisms on limited form factor devices can include omni-directional scroll balls, keyboard directional keys, and wheels. These traditional input mechanisms suffer from many constraints. These constraints result from the limited form factor of the mobile devices. That is, mobile devices frequently allow very little physical space for user input mechanisms (e.g., trackball, convenience keys, etc) due to their limited form factor. Consequently, mobile devices are often plagued by limited functionality, awkward user input usage, and cumbersome user input positioning, all of which results in failure to adequately duplicate desktop mouse functionality. As such, these input mechanisms do not permit a desktop user to interact with a mobile device using the same input behavior.

Many common desktop input behaviors (e.g., mousing actions) such as “drag and drop” and selection areas require simultaneous pointer movement and an input key selection. To accomplish this on current mobile devices, users are often forced to abandon desktop mousing behavior and utilize mobile device specific behaviors. For instance, copy/paste functionality can be performed on a workstation by a mouse drag and drop action whereas on a mobile device copy/paste functionality typically requires access to cumbersome menu entries to perform this simple operation. As such, standard desktop mousing events do not adequately map to mousing events on mobile devices.

In another instance, when an omni-directional pointer is present, scrolling typically requires a user to move the pointer from a point of interest on the screen to a screen edge and back again to the point of interest. This can quickly become tedious as the user constantly has to reposition the pointer for every action. It should be noted that this behavior of moving the pointer during scroll actions is different than the action taken with a standard-scroll event from a standard mouse, where a pointer remains in its original position when scrolling.

Lack of adequately robust interaction particularly affects content-rich user-input driven applications. For instance, on mobile devices ADOBE FLASH content triggered by actions such as “RollOvers” and “RollOuts” can fail. This is due to a disconnect between desktop mousing events and mousing events on mobile devices. As more content rich applications are delivered to mobile devices, a solution is required to stem the negative impact on user experience and application efficacy.

### BRIEF DESCRIPTION OF THE SEVERAL VIEWS OF THE DRAWINGS

FIG. 1 is a schematic diagram illustrating a system for an embedded omni-directional pointer component for limited form factor computing devices in accordance with an embodiment of the inventive arrangements disclosed herein.

FIG. 2A is a schematic diagram illustrating a set of embodiments for a MobilePointer embedded within a mobile computing device in accordance with an embodiment of the inventive arrangements disclosed herein.

FIG. 2B is a schematic diagram illustrating a set of MobilePointer configurations embedded within a mobile computing device in accordance with an embodiment of the inventive arrangements disclosed herein.

FIG. 3 is a schematic diagram illustrating a set of embodiments for embedding a MobilePointer input system within a mobile computing device in accordance with an embodiment of the inventive arrangements disclosed herein.

FIG. 4 is a schematic diagram illustrating a set of scenarios for replicating standard mouse events using a MobilePointer in accordance with an embodiment of the inventive arrangements disclosed herein.

FIG. 5 is a flowchart illustrating a method for replicating standard mouse events using a MobilePointer in accordance with an embodiment of the inventive arrangements disclosed herein.

### DETAILED DESCRIPTION

The present disclosure discloses a solution for an embedded omni-directional pointer component for limited form factor computing devices, such as hand held devices. In the solution, a MobilePointer component can be used to provide standard desktop mousing functionality to small form factor computing devices (e.g., mobile phones, media players, etc). In one embodiment, the component can comprise of an isometric joystick and three input buttons. The joystick and input buttons can be used in combination to provide a collection of complex mouse pointing functionality. The MobilePointer input component can be assembled into a variety of physical configurations and can be configured by software/firmware to operate in a platform dependent manner.

In one embodiment, the input buttons can include left click, right click, and scroll. In the embodiment the scroll can be used in conjunction with the isometric joystick to provide one handed scrolling capability. In one embodiment, the buttons and joystick can be arranged to provide a single thumb selection of all pointer options. Further, customized joystick/button combinations can be established by device manufacturer, application software, and/or users.

In another embodiment, the pointer input mechanism can be modularly mated to small form factor devices to provide primary and/or secondary input functionality. This mating can be performed during the manufacturing process or can be added to the device as an aftermarket component. The mating can add functionality to the device which can permit a user to interact with the device using an omni-directional pointer having standard mousing capabilities.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which runs via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which run on the computer or other programmable apparatus provide processes for implementing the functions/acts specified in the flowchart and/or block diagram block or blocks.

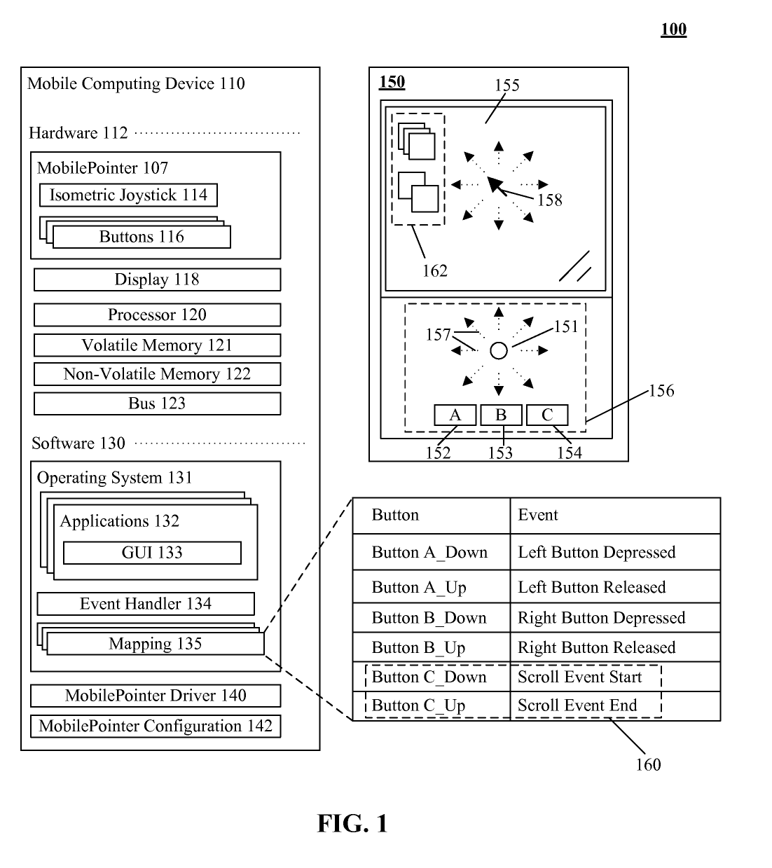

FIG. 1 is a schematic diagram illustrating a system 100 for an embedded omni-directional pointer component for limited form factor computing devices in accordance with an embodiment of the inventive arrangements disclosed herein. In system 100, a mobile computing device 110 can include a MobilePointer 107 enabling omni-directional and multi-input pointer capabilities to be present. The MobilePointer 107 can permit standard desktop mousing functionality to be replicated on device 110. That is, all standard mouse-actions and events triggered by mouse manipulations can directly map to user-intuitive manipulations of the MobilePointer 107.

As used herein, standard desktop mousing functionality can refer to actions and gesture based input achieved from a desktop computer mouse. Actions can include, but is not limited to, drag and drop actions, selection area actions, scrolling actions, zoom actions, gestures, and the like. In one embodiment, isometric joystick 151 and tactile buttons 152-154 can map to standard mousing events on device 155. Mousing events can include interactions with objects 162 using pointer 158. Objects 162 can include, but is not limited to, applications, graphical user interface (GUI) elements, icons, Universal Resource Identifiers, and the like. Mapping table 135 can be used to provide a variety of customizable mappings for which actions using pointer 158 can be assigned.

Hardware 112 can be physical digital components able to interoperate and run firmware/software. Hardware 112 can include MobilePointer 107, display 118, processor 120, volatile memory 121, non-volatile memory 122, and bus 123. MobilePointer 107 can include isometric joystick 114 and tactile buttons 116. In one embodiment, isometric joystick 114 can utilize a resistive strain gauge technology. In another embodiment, isometric joystick 114 can be implemented as an analog stick. Isometric joystick 114 and tactile buttons 116 can be shaped to conform to design considerations of the mobile computing device (e.g., aesthetics—hue, shape). Further, tactile buttons 116 can utilize a variety of tactile technologies including but not limited to, force resistive sensors, capacitive based sensors, and the like.

Display 118 can include a digital presentation component capable of displaying an omni-directional pointer and events which can be triggered by the pointer. Processor 120 can include general purpose digital circuit able to process input/output from components 118, 121-123. Volatile memory 121 can be memory able to temporarily store pointer information. Volatile memory 121 can include but is not limited to, random access memory (RAM), dynamic random access memory (DRAM), static random access memory (SRAM). Non-volatile memory 122 can include memory for permanently storing pointer information. Non-volatile memory 122 can include, but is not limited to read only memory (ROM), programmable read only memory (PROM), erasable programmable read only memory (EPROM), electrically erasable programmable read only memory (EEPROM). For instance, customized user settings (e.g., MobilePointer configuration 142) for pointer 158 can be stored in non-volatile memory 122. Bus 123 can be an input/output subsystem capable of transferring pointer information between components of hardware 112. As used herein, pointer information can include cursor position, acceleration data, input event data, applied force information, and the like.

Software 130 can be stored programmatic executable code residing on hardware 112. Software 130 can include, but is not limited to, operating system 131, MobilePointer driver 140, MobilePointer configuration 142. Operating system 131 can be a software interface for receiving MobilePointer 107 input and for interfacing with MobilePointer driver 140. Operating system 131 can include applications 132, event handler 134, mapping 135. Applications 132 can be software programs able to interact with an omni-directional pointer having standard mousing capabilities. Application 132 can include, but is not limited to, word processors, Web browsers, graphical programs, and the like. Event handler 134 can be a software element capable of receiving MobilePointer 107 input and mapping the input to one or more events within graphical user interface (GUI) 133. The applications 132 can be written to respond to standard mouse events, which will be directly and completely mapped to MobilePointer 107 actions. Thus, applications 132 need not be customized for mobile device specific pointer manipulation peripherals, which is the case for a majority of existing devices.

Mapping 135 can be an event map for correlating user input to application 132 and GUI 133 events. Mapping 135 can permit sophisticated user input such as gesture based input to be performed on device110. In one embodiment, mapping 135 can be user established which can vary between applications 132 and GUI 133. For instance, a tactile button 152 can be mapped to a zoom in/out function when a user is presented with a Web page in a Web browser. In another embodiment, tactile button 152 and 154 can be mapped to forward and backward history navigation. In yet another embodiment, mapping 135 can be device specific, permitting standardized functioning across multiple applications 132 and GUI 133. In one embodiment, mapping 135 can permit left-handed and right-handed configurations (e.g., swapping “left click” and “right click”) by establishing primary and secondary button configurations.

MobilePointer driver 140 can receive MobilePointer input 107 and can facilitate high level mapping 135 to occur. In one instance, MobilePointer driver 140 can support user input chording. In the embodiment, a user can utilize tactile button 153 and isometric joystick 151 simultaneously to perform scrolling actions in operating system 131. Utilizing mapping 135, complex chording user input can be achieved with MobilePointer 107.

In embodiment 150, a mobile device can include a MobilePointer input mechanism 156. In the embodiment, MobilePointer 156 can consist of isometric joystick 151 and tactile buttons 152-154. Isometric joystick 151 can be a 2-dimensional input device which can be manipulated in 360 degrees within a plane parallel to the surface of device 155, as shown by directional arrows 157. Joystick 151 can permit device 155 to have standard mousing functionality. In one configuration, joystick 151 can be force resistive allowing force applied by a user to joystick 151 to be used by operating system 131, application 132, and 133. For instance, joystick 151 can mimic a graphics tablet where joystick 151 force can be mapped to a variety of functions/behaviors (e.g., accelerated scrolling).

In one instance, MobilePointer 156 can natively support chording allowing multiple tactile button 152-154 and joystick 151 input to be captured and relayed to an event handler 134. For instance, as button B 154 is depressed and joystick 151 is manipulated, event 160 can be triggered causing a scroll event to start. In another instance, when tactile buttons 152-154 are pressed in unison, operating system 131 can present a task manager application.

In one embodiment, MobilePointer 156 can be an embedded component which can be integrated into a mobile computing device. The MobilePointer 156 can substitute and/or add extra input functionality to a mobile computing device.

Drawings presented herein are for illustrative purposes only and should not be construed to limit the invention in any regard. Mapping 135 can include operating system 131 level mapping, application 132 mapping, and/or GUI 133 mapping.

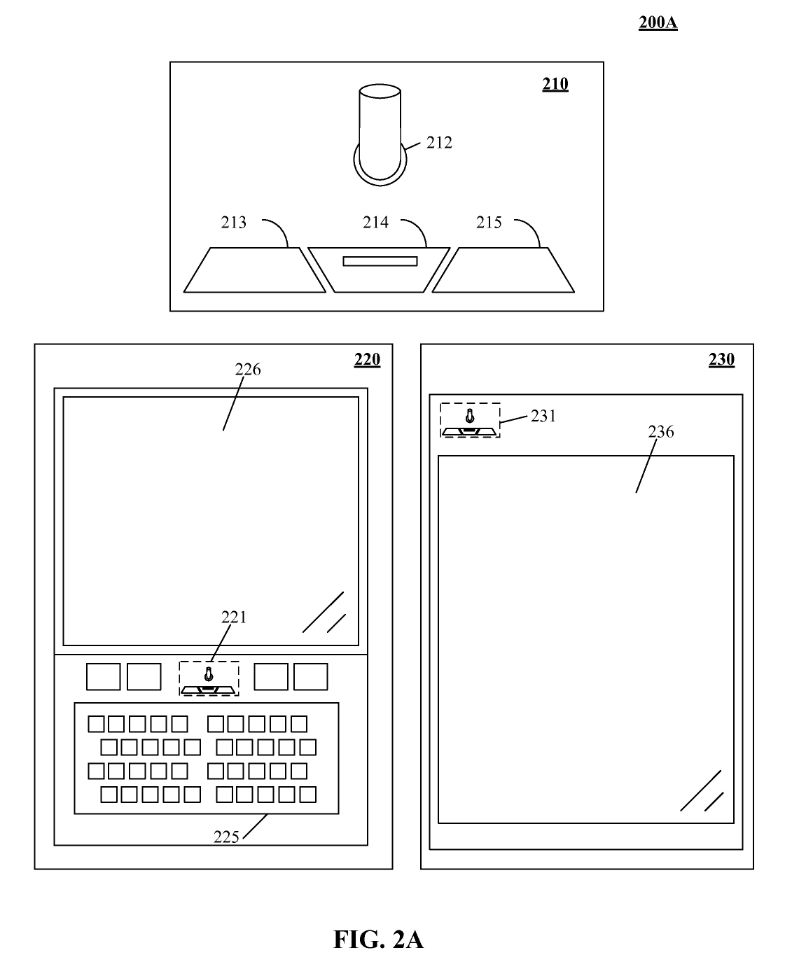

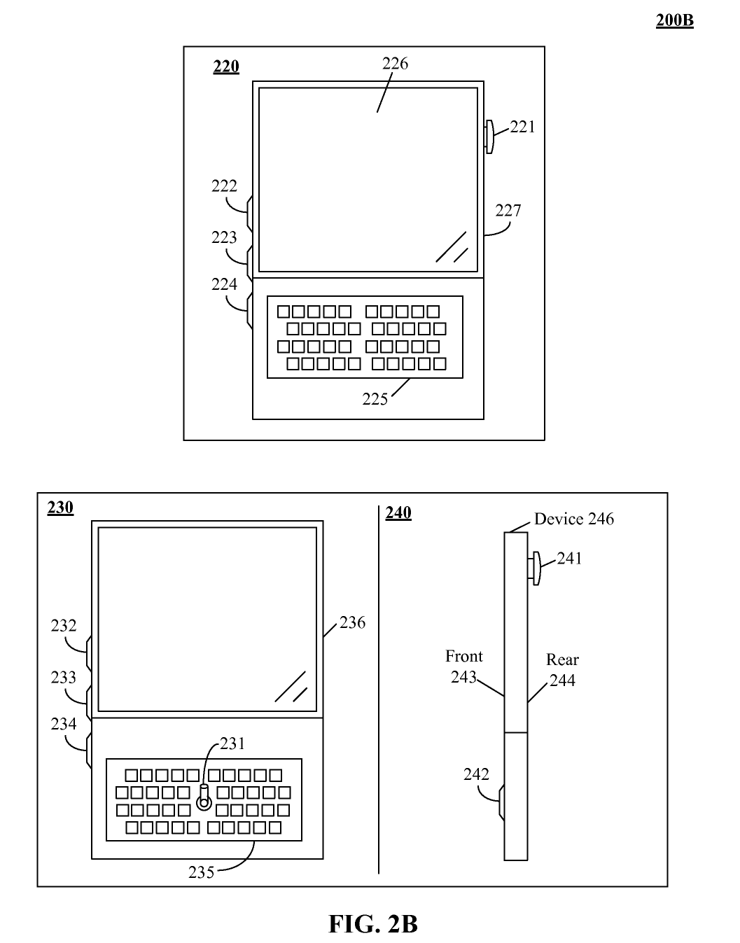

FIG. 2A is a schematic diagram illustrating a set of embodiments for a MobilePointer embedded within a mobile computing device in accordance with an embodiment of the inventive arrangements disclosed herein. In embodiment 210-230, a MobilePointer can be easily accommodated for mobile computing devices. In embodiment, MobilePointer 210 can be configured to integrate with limited form factor devices. In embodiment 220, MobilePointer 210 can be positioned on device 226 front surface between command keys. In embodiment 230, MobilePointer 210 can be positioned on the front surface of device 236. In one instance, configuration of input elements 212-215 can be similar or identical to IBM TRACKPOINT resulting in minimized learning curve penalties for prior TRACKPOINT users.

In embodiment 210, an enlarged view of MobilePointer 212-215 is illustrated. Embodiment of MobilePointer can comprise of isometric joystick 212 and three tactile buttons 213-215. In one arrangement of MobilePointer 212-215 element positions can be similar or identical to embodiment illustration 210. In the arrangement, joystick 212 can be proximately located above tactile buttons 213-215, centered over button 214. For instance, arrangement of joystick 212 and tactile buttons 213-215 can permit usage of embodiment 210 via thumb movement from the carpometacarpal joint. In another embodiment, joystick 212 can be located below tactile keys 213-215. It should be appreciated that the implemented dimensions for MobilePointer 212-215 can vary significantly from illustration 210.

In embodiment 220, MobilePointer 221 can be used to replace trackballs, a common technology on current smartphones. Since popular smartphones favor thumb navigation for the trackball, the elements of MobilePointer 221 can be scaled to fit between command keys (e.g., pickup, hang-up) on device 226. This is advantageous as it can permit embedding of MobilePointer 221 without requiring significant modification of current smartphone form factor. As such, the cost of integrating mobilepointer 221 into a limited form factor device can be minimal. The embodiment 220 can further permit a user to perform standard mousing operations using only one hand. That is, the thumb based user input behavior can remain relatively unchanged.

In embodiment 230, MobilePointer 231 can be embedded into limited form factor devices which utilize touchscreen technology. In the embodiment, MobilePointer 231 can be positioned in the upper left corner of device 236. The positioning of the MobilePointer 231 can permit an easily accessible alternate input mechanism for these devices.

It should be appreciated, embodiments 210-230 are not limited to smartphones and can be modified to embed MobilePointer into a variety of limited form factor devices.

FIG. 2B is a schematic diagram illustrating a set of MobilePointer configurations 220-240 embedded within a mobile computing device in accordance with an embodiment of the inventive arrangements disclosed herein. In embodiments 200B, a MobilePointer can be adapted to different configurations for mobile computing devices permitting a wide variety of limited form factor devices to have standard desktop mousing functionality. In embodiments 200B, the MobilePointer can be used as primary and/or secondary inputs. Further, the isometric joystick 221, 231, 241 and tactile buttons 222-224, 232-234, 242 can be independently positioned to accommodate limited form factor devices and to facilitate rapid and facile user input.

In embodiment 220, the isometric joystick 221 and tactile buttons 222-224 can be separately positioned on either lateral side of device 227. In embodiment 230, isometric joystick 231 can be positioned on the front of the device 236 and the tactile buttons 232-234 can be placed on a lateral side of the device 236. In embodiment 240, the isometric joystick 241 can be positioned at the rear of the device 244 and the tactile buttons 242 can be positioned at the front of the device 244.

In embodiment 220, MobilePointer components 221-224 can be secondary inputs on a mobile device 226. In the embodiment, a primary input component can include keyboard 225 and a secondary input component MobilePointer 221-224. Secondary input 221-224 can supplement or replace primary input 225 depending on device 226 configurations. Components 221-224 can be positioned on either side of the device resulting in the isometric joystick positioned on the opposing side of tactile buttons 222-224. Alternatively, isometric joystick 221 can be positioned on the same side as tactile buttons 222-224.

In embodiment 230, isometric joystick 231 can be placed on the front surface of device 236 and tactile buttons 232-234 can be located on a device side. The embodiment is advantageous in that it maintains a thumb based mousing behavior. In one configuration of the embodiment, isometric joystick 231 can be embedded within a keyboard 235.

In embodiment 240, isometric joystick 241 can be placed on the rear plane 244 of the device 246. In the embodiment, tactile buttons 242 can be positioned on the front plane 243 of the device 246. This configuration offers a significant benefit for devices designed to be held with one hand. In this configuration, usage of joystick 241 and buttons 242 allows a user to hold the device 246 in a manner which is natural. That is, user finger placement on device 246 permits quick and comfortable access of inputs 241, 242 while maintaining a secure hold on the device. In an alternative configuration, isometric joystick 241 can be fixed to the front plane 243 of device 246 while tactile buttons 242 can be positioned on the rear plane 244.

Drawings presented herein are for illustrative purposes only and should not be construed to limit the invention in any regard. Embodiments 220-240 can include any quantity of tactile buttons and are not limited to the quantities illustrated. In one instance, when only two tactile buttons are present, the two tactile buttons can be used in unison (e.g., chording) to emulate a third button.

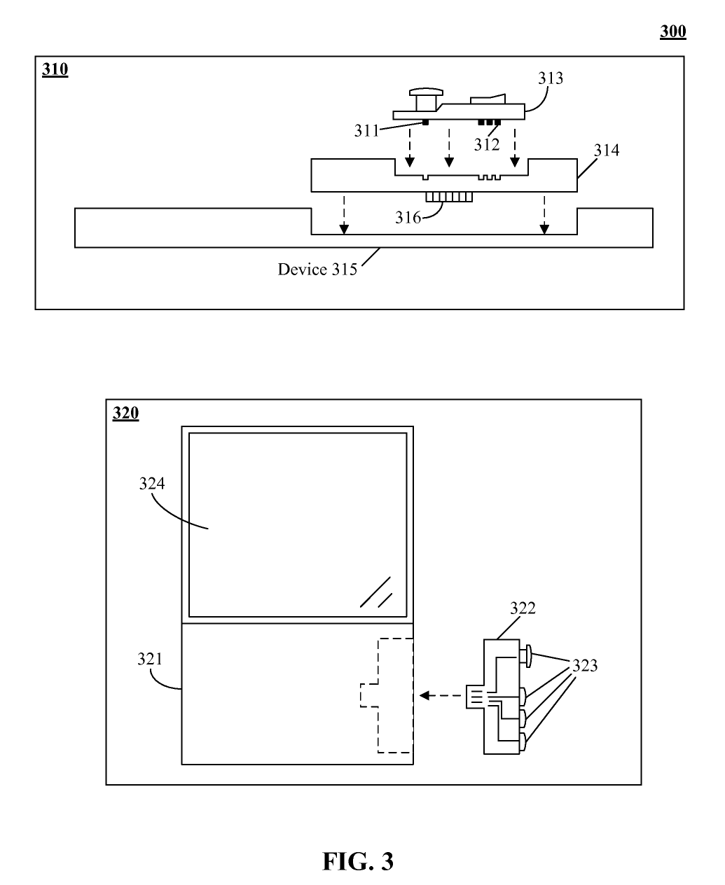

FIG. 3 is a schematic diagram illustrating a set of embodiment for embedding a MobilePointer input system within a mobile computing device in accordance with an embodiment of the inventive arrangements disclosed herein. The MobilePointer input component can be embedded within mobile computing devices (e.g., mobile phones, portable media players, etc.) as a licensable technology or as an aftermarket component.

In embodiment 310, MobilePointer input component can be integrated into an embedded device 315, a process which can occur during manufacturing. For instance, the MobilePointer 313 can be embedded into the front face of a device 315.

In embodiment 320, MobilePointer 322 can be socketed into mobile computing device 321, which can be performed as an aftermarket modification. For example, MobilePointer 322 can be slotted into the side face of the device. In the embodiments 310, 320 the MobilePointer 313, 322 can be used to provide an omni-directional pointer similar and/or identical to a computer mouse.

In embodiment 310, embedded device 315 can be a mobile computing device such as an Internet-enabled device (e.g., netbooks, lightweight computing devices). In one configuration, MobilePointer 313 can be integrated into circuitry 314 (e.g., keyboard circuitry mainboard) using connection points 311, 312. For instance, the MobilePointer 313 can be soldered into circuitry 314 and circuitry 314 can be embedded in device 315 via connection point 316. In the configuration, connection points 311 can correspond to an isometric joystick and connection points 312 can correspond to one or more tactile buttons.

Alternatively, the MobilePointer 313 can have a single connection point for integration into mobile computing device 315 circuitry. For instance, MobilePointer 313 can have pinout inputs which can be mated to a corresponding socket. It should be noted that circuit board 314 is not a required component of the embodiment 310 and be optionally omitted.

In embodiment 320, MobilePointer 322 can be socketed into device 321 as a user input add-on. In the embodiment, MobilePointer 322 can conform to a hotpluggable technology, enabling addition and removal of MobilePointer 322 to occur. In other configurations, MobilePointer 322 can be manufactured to be slotted into any area on device 321. For example, MobilePointer 322 can be a universal serial bus (USB) device which can be hotplugged into the side face of the device behind device display 324.

It should be appreciated, the disclosure is not limited to the embodiments described herein. Other embodiments are contemplated using embedded technologies, modular computing devices, and the like. In one configuration, MobilePointer 322 can be integrated into a layer allowing MobilePointer 322 to be overlayed or sandwiched between existing components. Other configurations for MobilePointer 322 which accommodate limited form factor devices can be achieved.

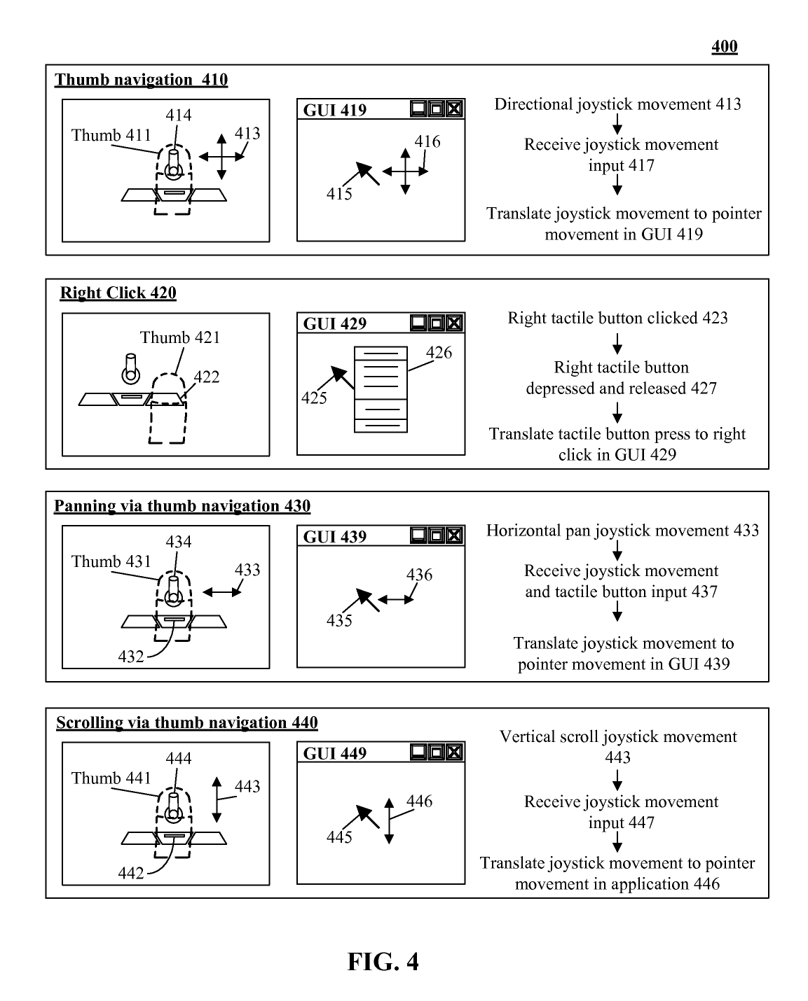

FIG. 4 is a schematic diagram illustrating a set of scenarios 410-440 for replicating standard mouse events using a MobilePointer in accordance with an embodiment of the inventive arrangements disclosed herein. In scenario 410-440, standard mouse events can be performed using a MobilePointer embedded within a limited form factor device. Standard mouse events can be achieved using a conventional thumb-based navigation scheme. For instance, a “home” finger position for many devices results in thumb placement on the center of the device where the input mechanism (e.g., trackball) is located. In embodiments 410-440, the “home” finger position can be joystick 414, 424, 434, 444. In embodiments 410-440, a user can navigate using a mouse pointer, trigger context menus, pan, and scroll using only a thumb finger. It should be appreciated the replication of standard mouse functionality can be achieved easily without requiring significant range of motion of a user's thumb finger from the “home” finger position (e.g., joystick). That is, joystick and tactile buttons can be adjacent to one another allowing users to rapidly select joystick and buttons.

In scenario 410, thumb 411 can be used to operate omni-directional joystick 414 to navigate in directions 413. Joystick navigation 413 can be received by graphical user interface (GUI) 419 as shown in action 417. Once received, navigation 413 can be translated into pointer 415 movement 416. The navigation 413 can be tightly or loosely mapped to user input permitting movements of joystick 414 to appropriately navigate pointer 415 in GUI 419. For instance, pointer 415 can be accelerated when a user manipulates joystick 414 aggressively.

In scenario 420, thumb 421 can be used to convey a right click mouse event to GUI 429. Thumb 421 can depress and release tactile button 423 which can be conveyed to GUI 429 as action 427. Based on mappings (e.g., mapping 135), action 427 can translated into right click in GUI 429. The right click event can trigger context menu 426 at cursor position 425.

In scenario 430, thumb 431 can operate joystick 434 while in contact with tactile button 432. For instance, the thumb joint (e.g., the distal and proximal phalanges joint) can depress button 442 while the tip of the thumb manipulates the joystick 434. Thumb 431 can be moved in a horizontal motion as shown by movement 433. GUI 439 can receive the joystick movement 434 and tactile button 432 input. The joystick movement 433 can be translated into a panning event. The panning event can cause pointer 435 to pan GUI 439 in direction 436. The pointer position 435 can remain constant while GUI 439 content is panned in direction 436.

In scenario 440, thumb 441 can operate joystick 444 while in contact with tactile button 442. Thumb 441 can be moved in a vertical motion as show by movement 443. GUI 449 can receive the joystick movement 443 and tactile button input 442. The joystick movement 443 can be translated into a scrolling event. The scrolling event can cause pointer 445 to scroll GUI 449 in direction 446. The pointer position 445 can remain constant while GUI 449 content is panned in direction 446.

Scrolling is not limited to the virtual direction 446, and can occur in any direction the joystick 444 is capable of moving. Some applications may, however, be limited to vertical scrolling by their coding. In one embodiment, horizontal scrolling is possible by holding button 442 and moving joystick 444 in a horizontal direction. In another embodiment, concurrent scrolling in both a horizontal and vertical direction is possible by holding button 442 while moving joystick 444 at an angle. In embodiments, where angled scrolling is possible, movements of joystick 444 can be optionally biased towards a vertical scrolling and/or a horizontal scrolling. That is, a snap-to direction feature can be implemented to minimize inadvertent scrolling at an angle, so that only designated directions of scrolling are possible (N, NE, E, SE, S, SW, W, NW) for example). In another embodiment, a snap-to feature can be a user configurable option, which when not enabled permits scrolling at any arbitrary angle indicated by joystick 444 movement.

Although, scenarios 410-440 illustrate a thumb based usage of MobilePointer, other fingers can be used to achieve the same mousing functionality.

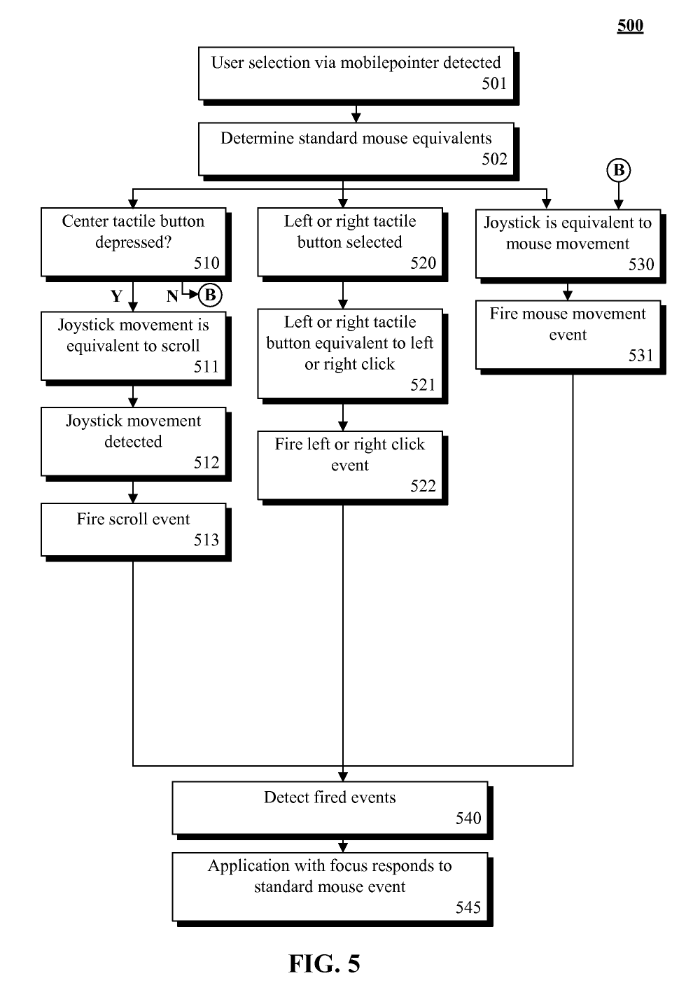

FIG. 5 is a flowchart illustrating a method for replicating standard mouse events using a MobilePointer in accordance with an embodiment of the inventive arrangements disclosed herein. In method 500, a MobilePointer on a limited form factor computing device can duplicate standard mouse events. The method 500 can be an input loop which can continuously detect and respond to user input events.

In step 501, a user selection within an application can be detected via a MobilePointer. MobilePointer 501 can comprise of an isometric joystick and three or more tactile buttons arranged to fit in a physical input area having limited space. In step 502, standard mouse equivalents can be determined from user input via MobilePointer. For instance, standard mouse equivalents such as scrolling and right click can be performed using MobilePointer. Steps 510-530 can be method flows which can be enacted based on user input.

In step 510, if the center tactile button is depressed, the method can proceed to step 511, else continue to step 530. In step 511, the joystick movement can be equivalent to a scrolling movement. Scroll movements can include movements in any direction able to be indicated by a joystick movement, which includes vertical scrolling, horizontal scrolling, and angled scrolling. In step 512, joystick movement is detected from user input. In step 513, a scroll event can fire.

In step 520, left and right tactile buttons can trigger left and right mouse click events. In the step 520, the left or right tactile button is selected by a user. In step 521, the left or right tactile button can be equivalent to left or right click. In step 522, the left or right click event can fire. In one instance, a left click can be a selection action and a right click can present contextual information.

In step 530, the joystick movement is equivalent to mouse pointer movement. In step 531, a mouse pointer movement event can fire.

In step 540, an event handler can detect fired events and convey the events to the application. In step 545, the application with focus can respond to standard mouse event.

The flowchart and block diagrams in the FIGS. 1-5 illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A hand-held mobile computing device comprising:
a processor;
a non-volatile memory;
a display screen;
an operating system digitally encoded in a computer program product stored in the non-volatile memory executable by the processor;
an interactive software application having a graphical user interface, wherein said interactive software application is digitally encoded in a computer program product stored in the non-volatile memory executable by the processor within the operating system;
a MobilePointer comprising:
an isometric joystick able to be moved in a plurality of positions from center comprising an upward position, an upward-right position, a right position, a lower-right position, a lower position, a lower-left position, a left position, an upper left position;
a right button, which is a user-selectable button;
a middle button, which is a user selectable button; and
a left button, which is a user selectable button;
mapping computer program product stored in the non-volatile memory configured to map selections of the MobilePointer to standard mouse events, wherein the right button corresponds to a right mouse button, wherein the left button corresponds to the left mouse button, wherein the middle button corresponds to a scroll enablement selection which interprets movement of the isometric joystick as applying to scroll operation in accordance with established mappings, and wherein movement of the isometric joystick without the middle button being selected maps to mouse movements in the joystick-indicated direction; and
a MobilePointer driver stored in the non-volatile memory executable within the operating system, configured to fire standard mouse events in accordance with mappings of the mapping computer program product responsive to user selections of the MobilePointer, wherein the interactive software application is configured to respond to the standard mouse events.

2. The hand-held mobile computing device of claim 1, wherein said MobilePointer consists of said isometric joystick, said right button, said middle button, and said left button, wherein said middle button is positioned below said isometric joystick, and wherein said right button is positioned below said isometric joystick and to the right of the middle button, and wherein said left button is positioned below said isometric joystick and to the left of the middle button,

3. The hand-held mobile computing device of claim 2, wherein no additional buttons or interactive controls are positioned between the isometric joystick, the right button, the middle button, and the left button.

4. The hand-held mobile computing device of claim 2, further comprising:
a keypad comprising discrete buttons for each letter of the alphabet, wherein a front face of the hand-held device comprises the keypad positioned in a lower portion of the front face, the display screen positioned on a top portion of the front face, and the MobilePointer positioned between the display screen and the keypad.

5. The hand-held mobile computing device of claim 2, further comprising:
a front face of the hand-held device comprising the display screen, where an area of the display screen is greater than seventy five percent of the area of the front face, wherein said MobilePointer is positioned above or below the display screen on the front face of the hand-held device.

6. The hand-held mobile computing device of claim 1, wherein said MobilePointer is configured for single-hand use while the mobile computing device is being held in a hand, wherein said single-hand use permits users to select any of the left button, middle button, right button, and isometric joystick, and wherein the middle button is able to be selected concurrently with moving the isometric joystick.

7. The hand-held mobile computing device of claim 1, wherein the isometric joystick is positioned on an opposing face of the hand-held mobile computing device from the right button, the middle button, and the left button.

8. The hand-held mobile computing device of claim 1, wherein the isometric joystick is positioned on a front face of the hand-held mobile computing device, and wherein the right button, the middle button, and the left button are positioned on a side of the mobile computing device.

9. The hand-held mobile computing device of claim 1, further comprising:
a motherboard comprising said processor, wherein said MobilePointer is an integrated peripheral formed on a single modular component, which is able to be electronically coupled to the motherboard.

10. A MobilePointer pointer controller for hand-held devices comprising:
an isometric joystick able to be moved in a plurality of positions from center comprising an upward position, an upward-right position, a right position, a lower-right position, a lower position, a lower-left position, a left position, an upper left position
a right button, which is a user-selectable button;
a middle button, which is a user selectable button; and
a left button, which is a user selectable button, wherein said MobilePointer is configured for single-hand use while a mobile computing device is being held in the hand that is manipulating the MobilePointer, wherein user-selectable manipulations of the MobilePointer map to standard mouse events.

11. The MobilePointer of claim 10, wherein said MobilePointer is configured for single-thumb use while a mobile computing device is being held in the hand that includes the thumb that is manipulating the MobilePointer.

12. The MobilePointer of claim 10, wherein user selectable controls of the MobilePointer consist of said isometric joystick, said right button, said middle button, and said left button, wherein said middle button is positioned below said isometric joystick, and wherein said right button is positioned below said isometric joystick and to the right of the middle button, and wherein said left button is positioned below said isometric joystick and to the left of the middle button, wherein no additional interactive controls are positioned between the isometric joystick, the right button, the middle button, and the left button.

13. The MobilePointer of claim 10, wherein said MobilePointer is a single modular component comprising a plurality of contact points, wherein said contact points are configured to be directly coupled to corresponding contact points of a motherboard of a hand-held device.

14. The MobilePointer of claim 10, wherein said isometric joystick and said right button, said middle button, and said left button are integrated into a motherboard of a hand-held device.

15. A method for manipulating a pointer in a graphical user interface of a hand-held device comprising:
receiving input from a user manipulating a MobilePointer with a single hand that is also holding a hand-held device comprising a screen, which presents a graphical user interface of an application with focus executing on an operating system, wherein said MobilePointer comprises an isometric joystick, a right button, a middle button, and a left button;
determining whether the user manipulations comprise movement of a isometric joystick, selection of the right button, selection of the middle button, selection of the left button, or combinations thereof,
mapping the determined user manipulations to standard mouse events using a mapping table, wherein said mapping table comprises direct mappings for a complete set of standard mouse events to manipulations of the MobilePointer;
firing at least one standard mouse event in accordance with mapping results; and
said application with focus performing at least one programmatic action in response to the fired at least one standard mouse event.

16. The method of claim 15, wherein said middle button is positioned below said isometric stick, and wherein said right button is positioned below said isometric stick and to the right of the middle button, and wherein said left button is positioned below said isometric stick and to the left of the middle button, said method further comprising:
detecting a user having placed their thumb over the isometric joystick and pressing the middle button at the same time;
detecting a motion of the joystick in a direction, while the middle button is depressed by the thumb, wherein the user manipulations comprise the movement of the joystick in the direction and the depressing of the middle button.

17. The method of claim 15, further comprising:
determining an upward movement of the isometric joystick, while the middle button is selected;
querying the mapping table to determine that the upward movement of the isometric joystick while the middle button is selected maps to a scroll up mouse event;
firing the scroll up mouse event;
said application responding to the scroll up mouse event;
determining a downward movement of the isometric joystick, while the middle button is selected;
querying the mapping table to determine that the downward movement of the isometric joystick while the middle button is selected maps to a scroll down mouse event;
firing the scroll down mouse event; and
said application responding to the scroll down mouse event.

18. The method of claim 15, further comprising:
determining an rightward movement of the isometric joystick, while the middle button is selected;
querying the mapping table to determine that the rightward movement of the isometric joystick while the middle button is selected maps to a zoom-in mouse event;
firing the zoom-in mouse event;
said application responding to the zoom-in event;
determining an leftward movement of the isometric joystick, while the middle button is selected;
querying the mapping table to determine that the leftward movement of the isometric joystick while the middle button is selected maps to a zoom-out mouse event;
firing the zoom-out mouse event; and
said application responding to the zoom-out mouse event.
